(19) United States
(12) Patent Application Publication
(10) Pub. No.: US 2025/0003452 A1
(43) Pub. Date: Jan. 2, 2025

(54) AUTOMATED DEVICE FOR LOCKING AND UNLOCKING BEARINGS

(71) Applicant: John Cockerill S.A., Seraing (BE)

(72) Inventor: Enrico TIRELLI, Villers-aux-Tours (BE)

(21) Appl. No.: 18/724,642

(22) PCT Filed: Sep. 16, 2022
(86) PCT No.: PCT/EP2022/075840

§ 371 Date: Jun. 27, 2024

(30) Foreign Application Priority Data
Dec. 30, 2021 (CN) 202111642672.9
Dec. 30, 2021 (CN) 202123392611.X

(51) Int. Cl. F16C 35/06; B05C 1/08; F16C 19/24

(52) U.S. Cl. CPC F16C 35/06; B05C 1/08; F16C 19/24; F16C 2237/00

(57) ABSTRACT

An installation for coating moving metal strips includes: a roller; a roller bearing connected to one end of the roller; an automatic locking and unlocking device for automatically locking and unlocking the roller, the automatic locking and unlocking device including: a support arm having a bearing seat for supporting the roller bearing, a movable retaining arm of the roller bearing, the movable retaining arm being pivotally mounted on the support arm about an axis parallel to the roller such that the movable retaining arm moves laterally away from the roller bearing when the movable retaining arm pivots, and an actuator for moving the movable retaining arm from a locking position to an unlocking position of the roller, the locking position being a position in which the roller is in use, and the unlocking position being a position allowing the roller to be removed from the device.

### CROSS-REFERENCE TO PRIOR APPLICATIONS

This application is a U.S. National Phase application under 35 U.S.C. § 371 of International Application No. PCT/EP2022/075840, filed on Sep. 16, 2022, and claims benefit to Chinese Patent Application No. CN 202111642672.9, filed on Dec. 30, 2021 and Chinese Patent Application No. CN 202123392611.X, filed on Dec. 30, 2021. The International Application was published in French on Jul. 6, 2023 as WO/2023/126082 under PCT Article 21(2).

### FIELD

The present invention relates to a device for automating the locking and unlocking of roller bearings for rollers used in installations for coating metal strips.

### BACKGROUND

In the field of coating metal strips, in particular in the steel industry, rollers are used to apply various liquid substances to moving strips, so as to cover the strips with the desired coating. The type of coating may be multiple, such as e.g. a paint, a lacquer, a varnish, a chemical surface treatment, an adhesive or any other type of substance which may have a variable degree of viscosity. The diversity of use of coated finished products leads to a wide variety of configurations of such coating installations. A large number of rollers are used in this type of installation, the rollers may be of different types, such as application rollers, tensioning rollers, angle guide rollers or support (or gripper) rollers on the application rollers.

To guarantee a high quality final result, the rollers (and more particularly the application rollers and the gripper rollers) should have an impeccable surface finish quality so as not to create appearance defects on the coated strip. This requirement involves a frequent replacement of the rollers.

Replacing the rollers thereby leads to a shutdown of the equipment, the shutdown lasting typically half an hour, which can entail a loss of production that may be substantial. Dismantling the rollers involves opening the bearing supports that contain the rolling elements of the roller shafts. The operation requires manual intervention. Moreover, such operation requires great care on the part of the operators, in particular to avoid soiling or damaging fragile movable parts. In addition, the operation is thus sometimes tedious, involving manual unscrewing or unlocking operations and, furthermore, exposes the operator to a hazard because the operator has to approach the line with potentially moving parts.

Document CN209370299U discloses a bearing seat in a rewinding machine of a production line for colored steel strips. The seat includes an upper body and a lower body surrounding the bearing so as to lock the bearing when the roller is in use. When the roller needs to be replaced, the upper body of the seat is raised vertically by means of a drive mechanism so as to release the bearing by sliding. More precisely, the upper body is attached to a slide and the rise thereof is actuated by a worm screw. The upper body cannot be completely removed from the mechanism and is simply lowered or raised vertically depending on whether the roller is in use or whether the bearing needs to be accessible. The disadvantage of such solution is that same does not completely free up the space for easy release of the rollers.

In document CN212564098U, the upper part of the cage also rises, guided by telescopic plates, so as to release the roller. However, this solution is not satisfactory either because same requires manual handling and leaves precision mechanical elements in a potentially soiled environment. Problems with the maintenance of the assemblies may arise depending on the use.

Document CN209772603U discloses a roller support comprising a lower support seat and an upper support seat for locking the roller bearing in use. The support further includes a quick-fastening system comprising mechanical elements such as a bolt, a fixed screw and a clamping handle. A screw hole is provided in the lower part of the lower support seat, while a vertical groove is provided in the upper support seat, all elements cooperating to removably attach the upper support to the lower support.

Document U.S. Pat. No. 6,718,876 B1 relates to a method and an apparatus, in a roller printing unit, for locking the rollers in bearing housings, in relation to the movement of the rollers from the open position to the working position. The movement of the rollers in relation to the printing unit frame is used to mechanically operate locking devices on the roller bearing housings between the open and closed positions during the movement operation.

### SUMMARY

In an embodiment, the present invention provides an installation for coating moving metal strips, comprising: a roller; a roller bearing connected to one end of the roller; and an automatic locking and unlocking device configured to automatically lock and unlock the roller, the automatic locking and unlocking device comprising: a support arm comprising a bearing seat configured to support the roller bearing, a movable retaining arm of the roller bearing, the movable retaining arm being pivotally mounted on the support arm about an axis parallel to the roller such that the movable retaining arm is configured to move laterally away from the roller bearing when the movable retaining arm pivots, and an actuator configured to move the movable retaining arm from a locking position to an unlocking position of the roller, the locking position being a position in which the roller is in use, and the unlocking position being a position allowing the roller to be removed from the device, wherein the roller bearing is configured to rest on the bearing seat of the support arm and, in normal use, has no contact with the movable retaining arm, which defines a minimum gap of at least one hundredth of a millimeter between the movable retaining arm and the roller bearing, and wherein the movable retaining arm is configured to allow the roller bearing to be retained if the roller bearing abnormally leaves the bearing seat.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 illustrates a perspective view of an embodiment of a system for locking and unlocking bearings according to the present invention, the retaining arm being in the locking position.

FIG. 2 is a perspective view of the embodiment shown in FIG. 1, with the retaining arm in the unlocking position.

FIG. 3 is a profile view of the embodiment shown in FIG. 1, with the retaining arm in the locking position.

FIG. 4 is a profile view of the embodiment shown in FIG. 1, with the retaining arm in the unlocking position.

FIG. 5 is a longitudinal sectional view of the embodiment of FIG. 1, with the retaining arm in the locking position.

FIG. 6 is a longitudinal sectional view of the embodiment shown in FIG. 1, with the retaining arm in the unlocking position.

### DETAILED DESCRIPTION

In an embodiment, the present invention provides a solution that facilitates the maintenance and rapid replacement of the rollers by means of an easy release and attachment of the roller bearings.

In an embodiment, the invention provides an automated solution enabling the operator to remotely perform the locking and unlocking of the bearings, thereby ensuring increased safety of the operation.

In an embodiment, the invention provides a system which is safe for operators and which serves to increase productivity and reduce the operation cost related to the locking/unlocking of the bearings, due to the drastic reduction in the time required for maintaining the rollers.

The present invention relates to a device for automatically locking and unlocking a roller in an installation for coating moving metal strips, said device comprising:
a support arm comprising a bearing seat suitable for supporting a roller bearing, said roller bearing being connected to one end of the roller
a movable retaining arm of the roller bearing, said movable retaining arm being pivotally mounted on the support arm about an axis parallel to the roller, in such a way that the movable retaining arm moves laterally away from the roller bearing when the movable retaining arm pivots;
an actuator serving, in use, to move the movable retaining arm from a locking position to an unlocking position of the roller, the locking position being the position in which the roller is in use and the unlocking position being the position allowing the roller to be removed from the device;
said device being characterized in that the roller bearing rests on the bearing seat of the support arm and, in normal use, has no contact with the movable retaining arm, which defines a minimum gap between the movable retaining arm and the roller bearing, said movable retaining arm allowing the roller bearing to be retained if the roller bearing abnormally leaves the bearing seat.

The function of the above characterizing part is, on the one hand, to reduce friction in the locking position and, on the other hand, to ensure safety.

According to preferred embodiments of the invention, the automated device further comprises one of the following features, or a suitable combination thereof:
the movable retaining arm is housed inside the support arm;
the angular travel of the movable retaining arm during the pivoting thereof is limited both by the angular position corresponding to said minimum gap and by the angular position corresponding to the unlocking position
the movable retaining arm comprises an upper part adjacent to the roller bearing in use, in the form of an arc of a circle which does not cover at least an upper section of the roller bearing, so as to allow the roller to be removed when the movable retaining arm is pivoted laterally into the unlocking position
the movable retaining arm has a geometry and a weight distributed such that it is naturally in the unlocking position by gravity, and is characterized in that the actuator is designed to press on the movable retaining arm so as to tilt same, in use, from the unlocking position to the locking position;
a return spring is provided to ensure full unlocking by gravity;
the actuator is a single-acting or double-acting, pneumatic, hydraulic or electric cylinder, preferably remotely controlled;
a shim is provided on the movable retaining arm, said shim being adjusted to allow the movable retaining arm to abut against the support arm and to prevent contact, or to limit the contact force, between the movable retaining arm and the roller bearing;
the shim is attached to the movable retaining arm using a threaded rod passing through the shim so as to attach the shim in a bore provided in the movable retaining arm.

The present invention solves the technical problem described hereinabove and provides a device for attaching the rollers that is convenient, fast and reliable.

Unlike the systems of the prior art, the bearing attachment system according to the invention is operated from the bottom and not from the top.

The above is a small locking device with a carefully calculated overall size that keeps the application roller in place during the time needed for the entire operation and which allows easy release of the roller by a simple external automatic control. Each roller bearing is located in a housing having a shape making it possible to limit the absorption of forces by the locking mechanism. The greatest force comes from the gripper roller which presses against the application roller. The device requires an actuator pressing on a lever, the rotation axis of which is off-center. The off-centering ensures that the weight of the roller rests on the frame and not on the closing system. Furthermore, a retaining plate, the function of which is already known per se, limits any possible lateral movement of the roller.

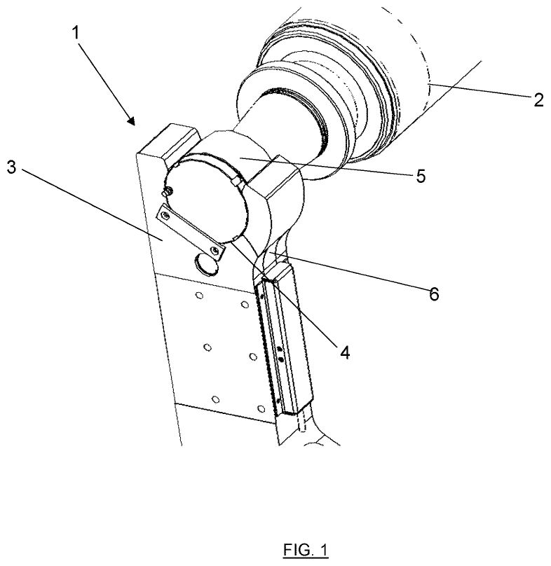

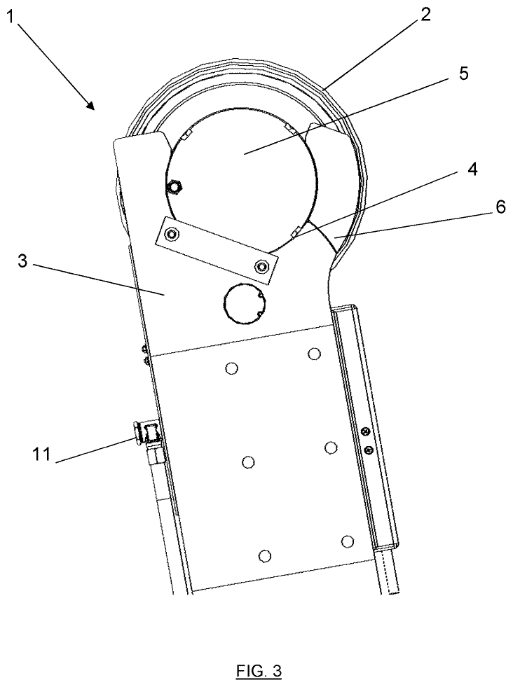

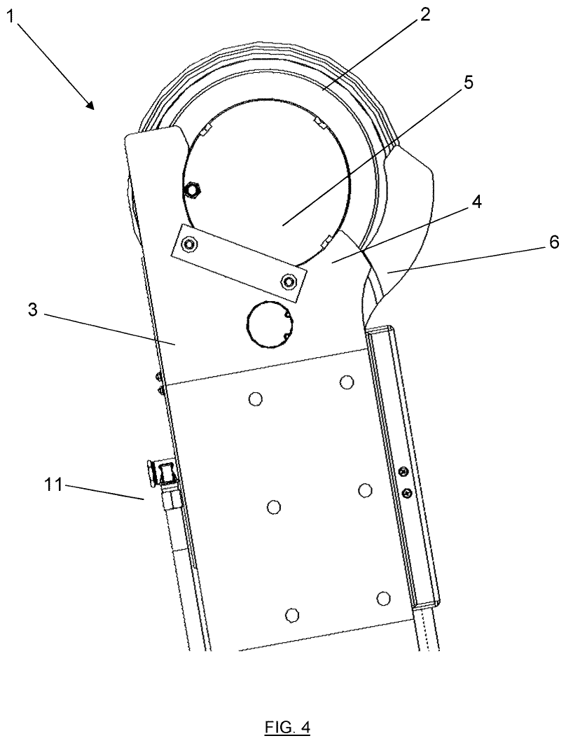

An embodiment of the device 1 for locking and unlocking bearings according to the present invention is shown in FIGS. 1 to 6. The system consists of an automated device for locking and unlocking rollers designed for installations for coating moving metal strips.

As explained earlier, rollers, such as application rollers, should be replaced regularly to ensure optimum coating quality.

The rollers are held at their ends by roller bearings. The roller bearings, known per se from the prior art, are held by a bearing seat which is a device supporting the bearing from the outside, by attaching the outer ring of the bearing (in small machines, the rolling element is directly in contact with the seat, without an intermediate bearing). In this way, the inner ring is free to rotate and drive the roller, whereas the outer ring remains stationary.

For a roller to be replaced, the operator has to have access to the roller bearings. The device of the present invention allows the bearings to be released in an automated manner. The above means that the process of locking and unlocking the bearings takes place by mechanical means without direct human intervention.

For this purpose, the locking and unlocking device comprises a support arm 3, the upper part of which forms a bearing seat 4. The function of the bearing seat 4 is to support a roller bearing 5 which is connected to one end of the roller 2 so as to hold same during the surface coating operation.

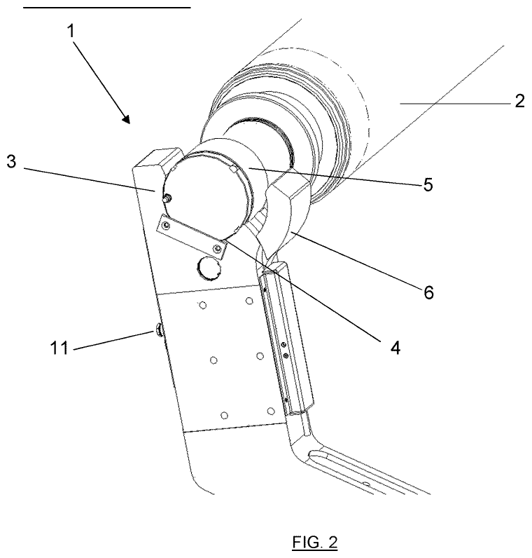

In the context of the present invention, a movable retaining arm 6 is housed inside the support arm 3 as shown in FIGS. 1 and 2. The purpose of the retaining arm 6 is to secure the position of the roller bearing 5 in the bearing seat 4. More precisely, the retaining arm 6 is pivotally mounted in the support arm 3, about an axis parallel to the roller 2. In this way, the retaining arm 6 can switch from a position wherein the roller bearing 5 is locked, as illustrated in FIGS. 1, 3 and 5, to a position wherein the roller bearing 5 is unlocked, as illustrated in FIGS. 2, 4 and 6.

In the locking position, the roller 2 is also in the operating position. The roller is thereby held at its ends by the roller bearings 5 which are positioned in the bearing seats 4 of the support arms 3. The retaining arms 6 close the bearing seats 4 laterally to secure the locking device 1 of the roller 2. In this configuration, the roller bearings 5 rest against the bearing seats 4 of the support arms 3. In normal use, i.e. when the roller is positioned in the bearing seat 4, the roller bearing 5 has no contact with the movable retaining arm 6. Indeed, the movable retaining arm 6 serves to retain the roller bearing 5 in case the latter leaves the bearing seat 4 and thus has a safety/retaining function. A gap of at least one hundredth of a mm may be provided between the retaining arm 6 and the roller bearing 5 when the movable retaining arm 6 is in the locking position. In this way, the roller bearings 5 do not rest on the movable retaining arms 6, but on the support arms 3.

However, the gap of 0.01 mm is not mandatory, as contact is acceptable if it is a surface contact without any deformation of the bearing.

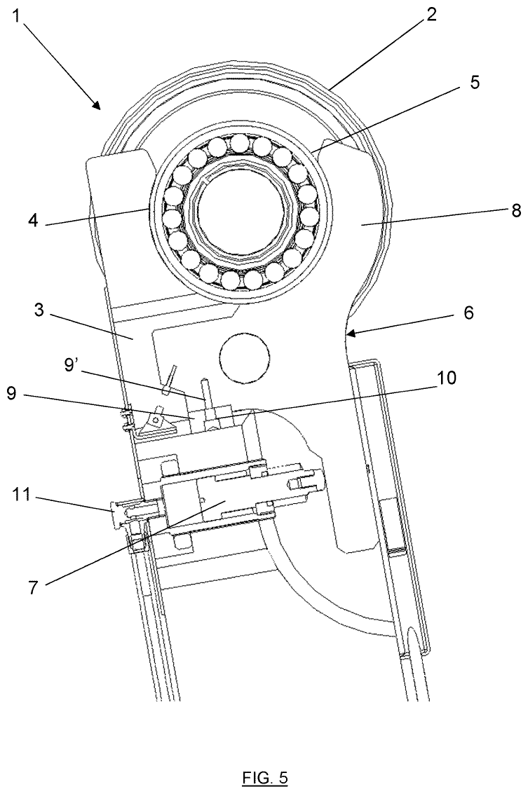

In the unlocking position, the movable retaining arm 6 is in the open position, i.e. same has pivoted about its rotation axis so as to move away from the bearing seat 4. In this configuration, the roller bearing 5 is accessible and the roller can be easily removed from the device. At present, no element blocks the vertical passage above the bearing seat, and it is now easier to handle the roller. Preferably, the upper part 8 of said movable retaining arm 6, the upper part 8 being the part adjacent to the roller bearing 5, is in the form of an arc of a circle and is located at least partly under the roller bearing 5 and/or laterally with respect to the latter, the locking of the roller 2 thereby taking place laterally (FIG. 5). Consequently, the upper part 8 of the movable retaining arm 6 does not cover, in any case, the roller bearing 5 from above, but only from below and laterally.

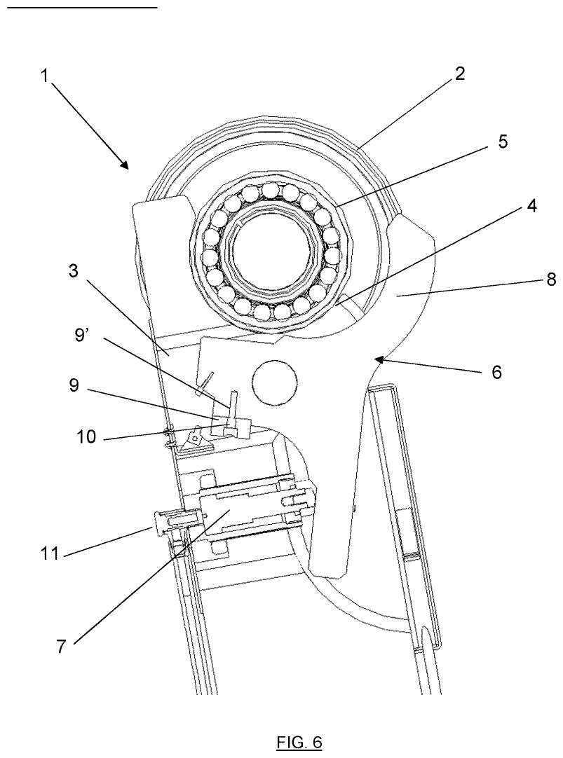

Since the device according to the present invention is automated, the device comprises an actuator 7 serving, in use, to switch the retaining arm 6 from the locking position to the unlocking position. FIGS. 5 and 6 illustrate the thrust of the actuator 7 on the retaining arm 6, which then switches from the unlocking position to the locking position and vice versa. In the illustrated embodiment, the movable retaining arm 6 has a geometry and a weight distributed such that same is, in its default position, in the unlocking position due to gravity, and, in use, the actuator 7 presses on the movable retaining arm 6 so as to switch the arm 6 from the unlocking position to the locking position. A return spring may be provided to help gravity ensure full release. The actuator 7 can be a single-acting or double-acting, pneumatic, hydraulic or electric cylinder. An actuating button 11 of the actuator 7 may be provided on the support arm 3 and may be remotely activated by an operator.

A shim 9 is provided on the movable retaining arm 6, allowing the movable retaining arm 6 to abut against the support arm 3, thereby preventing contact between the movable retaining arm 6 and the roller bearing 5. The shim 9 is attached to the movable retaining arm 6 by means of a threaded rod 9′ passing through the shim 9 so as to attach the shim in a bore 10 provided in the movable retaining arm 6. Preferably, the bore 10 is made in situ in the movable retaining arm 6 so as to ensure an exact position of the latter, as the spacing between the movable retaining arm and the roller bearing 5 has to be precisely adjusted.

To automate the system for locking and unlocking the bearings, one of the challenges of the present invention was to place all the functional elements inside the support arm 3. The aim also being to prevent blocking the bearing 5 from above, so as to ensure easy access to the bearing 5, the design of the geometry of the retaining arm 6 and of all the mechanical elements located inside the supporting arm 3, to lock the bearing from below, was a real technical problem solved by the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Locking and unlocking device
2 Roller
3 Support arm
4 Bearing seat
5 Roller bearing
6 Retaining arm
7 Actuator
8 Upper part of the retaining arm
9 Shim
9′ Threaded rod
10 Bore for the shim
11 Actuating button

1: An installation for coating moving metal strips, comprising:
a roller;
a roller bearing 45 connected to one end of the roller and
an automatic locking and unlocking device configured to automatically lock and unlock the roller the automatic locking and unlocking device comprising:
a support arm comprising a bearing seat configured to support the roller bearing,
a movable retaining arm of the roller bearing, the movable retaining arm being pivotally mounted on the support arm about an axis parallel to the roller in such a way that the movable retaining arm metes is configured to move laterally away from the roller bearing when the movable retaining arm pivots, and
an actuator configured to move the movable retaining arm from a locking position to an unlocking position of the roller, the locking position being a position in which the roller is in use, and the unlocking position being a position allowing the roller to be removed from the device,
wherein the roller bearing is configured to rest on the bearing seat of the support arm and, in normal use, has no contact with the movable retaining arm, which defines a minimum gap of at least one hundredth of a millimeter between the movable retaining arm and the roller bearing, and
wherein the movable retaining arm is configured to allow the roller bearing to be retained if the roller bearing abnormally leaves the bearing seat.

2: The installation of claim 1, wherein the movable retaining arm is housed inside the support arm.

3: The installation of claim 1, wherein an angular travel of the movable retaining arm during pivoting thereof is limited both by an angular position defined by the minimum gap and by an angular position corresponding to the unlocking position.

4: The installation of claim 1, wherein the movable retaining arm comprises an upper part adjacent to the roller bearing comprising an arc of a circle which does not cover at least an upper section of the roller bearing, so as to allow the roller to be removed when the movable retaining arm is pivoted laterally into the unlocking position.

5: The installation of claim 1, wherein the movable retaining arm has a geometry and a weight distributed such that the movable retaining arm is naturally in the unlocking position by gravity, and
wherein the actuator is configured to press on the movable retaining arm so as to tilt the movable retaining arm from the unlocking position to the locking position.

6: The installation of claim 5, further comprising:
a return spring configured to ensure full unlocking of the movable retaining arm by gravity.

7: The installation of claim 1, wherein the actuator comprises a single acting or double acting, pneumatic, hydraulic or electric cylinder.

8: The installation of claim 1, wherein a shim is provided on the movable retaining arm, the shim being adjusted adjustable to allow the movable retaining arm to abut against the support arm and to prevent contact, or to limit a contact force, between the movable retaining arm and the roller bearing.

9: The installation of claim 8, wherein the shim is attached to the movable retaining arm by a threaded rod passing through the shim so as to attach the shim in a bore provided in the movable retaining arm.

10: The installation of claim 7, wherein the actuator is remotely controlled.
